(19) United States
(12) Patent Application Publication
(10) Pub. No.: US 2010/0228384 A1
(43) Pub. Date: Sep. 9, 2010

(54) METHOD AND DEVICE FOR GENERATING TRANSFORMED CONTROL DATA FOR CONTROLLING A TOOL ON A MACHINE TOOL

(75) Inventors: Josef NEUMAIER, Pfronten (DE); Thomas LOCHBIHLER, Vils (AT); Uwe-Carsten HANSEN, Eisenberg (DE)

Correspondence Address: OLIFF & BERRIDGE, PLC, P.O. BOX 320850, ALEXANDRIA, VA, 22320-4850, US

(73) Assignee: DECKEL MAHO PFRONTEN GMBH, PFRONTEN (DE)

(21) Appl. No.: 12/702,649

(22) Filed: Feb. 9, 2010

(30) Foreign Application Priority Data
Feb. 9, 2009 (DE) DE102009008121.6

(51) Int. Cl. G05B 19/406

(52) U.S. Cl. 700/173; 700/174

(57) ABSTRACT

The invention relates to a method and a device for generating transformed control data for controlling a tool on a machine tool for machining a workpiece clamped in a clamping means of the machine tool, including the steps of: (1) determining control data indicating which first tool path is to be traveled by the tool of the machine tool with which first tool orientation for machining the clamped workpiece if the workpiece is clamped in the clamping means in accordance with a clamping situation target state means; (2) detecting a clamping situation current state; (3) detecting a clamping situation deviation between the clamping situation current state and the clamping situation target state; and (4) generating transformed control data by executing a transformation of a part of the determined control data in dependence of the detected clamping situation deviation.

The present invention relates to a method and a device for generating transformed control data for controlling a tool on a machine tool for machining a workpiece clamped in a clamping means of the machine tool.

Particularly, the invention relates to a method and a device for generating transformed control data for controlling a predetermined milling tool on a CNC-controlled machine tool, in particular a CNC-controlled milling, turning, milling/turning machine or turning/milling machine or a CNC-controlled machining center for machining a workpiece clamped in the machine tool or the machining center, in particular for machining the workpiece from a blank to a finished part having a predetermined finished part geometry.

### BACKGROUND OF THE INVENTION

The prior art discloses CNC-controlled machine tools in different embodiments.

CNC (“computerized numerical control”) means that the machine tool is numerically controlled, e.g. by using a generated NC program or CNC program. The machine tool is suitable to be equipped with a tool that removes material from the workpiece by machining. The control of the tool during this process is executed by means of a control device using control data, e.g. control data predetermined by using a CNC program. Thus, a precise machining of a workpiece clamped in the machine tool by using the generated control data becomes possible.

According to the prior art, CNC programs are written in a software-supported manner by means of CAM system (CAM for “computer-aided manufacturing”) and CAD/CAM systems. A generated CNC program comprises movement instructions which direct a tool inserted in a receiving means of a milling head of the machine tool relative to a workpiece clamped in the machine tool along a generated path in order to remove material of the workpiece along the path while traveling the path.

In this case, the path calculation is based on geometric dimensions and is geared by the intended finished part geometry of the workpiece, material of the workpiece being generally removed path by path by traveling the calculated tool paths until the finished part contour is achieved. For this purpose, the control data may additionally comprise instructions which automatically instruct a change of tool by program-control during the machining of the workpiece in the machine tool and/or automatically instruct changes of the workpiece by program-control so that these changes of tool and/or changes of workpiece are automatically executed by program-control on the machine tool by using the control data.

CNC-controlled machine tools comprising at least 5 axes which make it possible to freely move the tool in 5 degrees of freedom through the space for removing the material from the workpiece are particularly universally usable, the 5 degrees of freedom of movement comprising here the 3 spatial direction degrees of freedom (in most cases, orthogonal, e.g. referred to as x-axis, y-axis and z-axis) and 2 angle or rotation degrees of freedom enabling an arbitrary tool orientation or tool orientation control. Today's CNC machine tools having 5 axes make it possible to simultaneously drive the 5 so-called degrees of freedom of the 5 axes by program-control, wherein the prior art furthermore discloses CNC machine tools that comprise 6 axes, in particular 3 axes of translation and 3 axes of rotation, in order to simultaneously drive the 5 degrees of freedom of the tool control by program-control via 6 axes. In principal, machine tools having more than 6 axes are also possible.

However, in the CNC machine tools disclosed by the prior art problems arise because the control data is calculated and generated, respectively, under certain preconditions, predetermined conditions and/or assumptions, in particular assumptions on an actual clamping situation of the workpiece. Thus, it is specifically necessary, for example for generating control data, that a position or posture of the workpiece in the state of being clamped in a clamping means of the machine tool be known so that paths as precise as possible may be calculated for generating control data that accurately gives a tool position and/or a tool orientation relative to the workpiece in a clamping situation target state underlying the path calculation or relative to the clamping means in which the workpiece is clamped.

Therefore, methods for generating control data according to the prior art particularly presuppose or assume for the calculation of paths that a workpiece to be machined is precisely clamped in the clamping means of the machine tool in accordance with the ideal clamping situation target state. Consequently, when the workpiece is machined by a tool while traveling a calculated tool path by using the generated control data, it is furthermore necessary that the position and posture or orientation of the workpiece in the clamping means exactly correspond to the clamping situation target state which forms the basis for the calculation of the path data in order to be able to precisely machine the workpiece in accordance with the calculations. In this process, the problem consequently arises that a workpiece is machined in a faulty or imprecise manner when it is machined in the machine tool by using the generated control data if the workpiece is clamped in the clamping means in a fashion deviating from the clamping situation underlying the path calculation or deviating from the clamping situation target state of the workpiece.

DE 10 2007 016 056 A1 discloses that in the machining of a workpiece on a laser ablation machine a rotational or translational offset of a clamped workpiece is optically measured. Based on the detected offset, initial manufacturing data, i.e. CAD/CAM data, is modified and control data, that is e.g. an NC program, is generated from the CAD/CAM manufacturing data in dependence of the detected actual clamping of the workpiece, which program is then supplied to the laser ablation machine. However, this is problematic because in the case of the successive machining of equal workpieces, for example in mass production, CAD/CAM manufacturing data must be modified for each workpiece, control data must again be generated based on the manufacturing data which control data then has to be transmitted to the machine again for each workpiece although the actual workpiece machining to be performed remains the same. Thus, the method disclosed by DE 10 2007 016 056 A1 is suitable only for single machining of individual workpieces and is not suited for mass productions on machine tools and for workpiece machining on machine tools, respectively, where a plurality of workpieces is to be subjected to the same machining.

DE 196 31 620 A1 discloses a method in which an inclination of the workpiece axis to the axis of a rotary table on which the workpiece is clamped is determined in case of rotationally symmetric workpieces that are subjected to machining by a grinding wheel on a grinding machine. The feed motion of the grinding wheel will then be adjusted in accordance with the determined inclination of the workpiece axis to the rotational axis of the workpiece table. However, in this case, merely the inclination error of the rotationally symmetric workpiece is determined and taken into consideration when machining. A translational displacement of the clamped workpiece is not considered. In case of the simple machining of a gear wheel by using a grinding wheel it is only necessary to move the grinding wheel in parallel to the workpiece axis. An exact determination of the displacement of the workpiece in the actual clamping situation in the direction of the workpiece axis is not required and thus is not provided for either according to the teaching of DE 196 31 620 A1. Thus, the method disclosed by DE 196 31 620 A1 is particularly not suitable for machining non-rotationally symmetric workpieces on a machine tool. Furthermore, the method is not suited for more complex machining, for example on a machine tool comprising at least 5 axes on which not only a simple grinding movement of a grinding wheel in parallel to the workpiece axis of a rotationally symmetric workpiece is executed but on which complicated movements of the tool relative to the workpiece must be controlled in 5 degrees of freedom with optionally changing milling or drilling tools, such as, for example, end milling cutters, torus milling cutters, cherries or even drum milling cutters or other drilling or milling tools.

### SUMMARY OF THE INVENTION

It is an object of the present invention to provide a method, a device and a computer program product for generating transformed control data for controlling a tool on a machine tool for machining a workpiece clamped in a clamping means of the machine tool which are able to avoid the above-described problems of the method according to the prior art.

Particularly, it is an object of the present invention to provide a method, a device and a computer program product for generating transformed control data for controlling a tool on a machine tool for machining a workpiece clamped in a clamping means of the machine tool in which a faulty or imprecise machining of a workpiece can be avoided even if the workpiece is clamped in a clamping means of the machine tool in an imprecise manner or a manner deviating from the clamping situation target state.

Additionally, according to the invention, a method and a device for controlling a tool on a machine tool for machining a workpiece clamped in a clamping means of the machine tool are provided, comprising the method steps:
determining control data for controlling the tool of the machine tool along a first tool path having a determined first tool orientation for machining the clamped workpiece in accordance with a clamping situation target state indicating a target state of a clamping situation of the workpiece clamped in the clamping means,
detecting a clamping situation current state indicating an actual current state of the clamping situation of the workpiece clamped in the clamping means,
detecting a clamping situation deviation between the clamping situation current state and the clamping situation target state indicating a deviation between the clamping situation current state and the clamping situation target state, and
controlling the tool in dependence of the determined clamping situation deviation such that the tool of the machine tool travels along a second tool path having a determined second tool orientation for machining the clamped workpiece.

According to the invention, the above-described objects are achieved by a method for generating transformed control data for controlling a tool on a machine tool for machining a workpiece clamped in the clamping means of a machine tool according to claim 1 and a corresponding device for generating transformed control data according to claim 9.

Furthermore, the present invention provides a machine tool having at least 5 axes for machining a workpiece by means of a tool by using transformed control data according to claim 13, which machine tool comprises an inventive device as described above.

Furthermore, the present invention provides a computer program product according to claim 16 and a data carrier according to claim 17 on which the computer program product according to the invention is stored.

Preferred embodiments and examples of the present invention are described by the dependent claims.

The inventive method for generating transformed control data for controlling a tool on a machine tool for machining a workpiece clamped in the clamping means of the machine tool comprises the method step of determining control data indicating which first tool path is to be traveled by a tool of the machine tool having which first tool orientation for machining the clamped workpiece if the workpiece is clamped in the clamping means in accordance with a clamping situation target state indicating a target state of a clamping situation of the workpiece clamped in the clamping means.

Particularly, the method according to the invention is characterized by the following further method steps:
Detecting a clamping situation current state indicating an actual current state of the clamping situation of the workpiece clamped in the clamping means,
detecting a clamping situation deviation between the clamping situation current state and the clamping situation target state indicating a deviation between the clamping situation current state and the clamping situation target state, and
generating transformed control data by executing a transformation of at least a part of the determined control data in dependence of the determined clamping situation deviation.

Here, the term clamping situation current state refers to the actual clamping situation of the clamped workpiece so that the clamping situation deviation in the sense of the invention includes rotational as well as translational deviations from the clamping situation target state.

This is advantageous in that the method for generating control data according to the present invention is executed not only by using a predetermined and/or underlying clamping situation target state but additionally at least by using an detected actual clamping situation current state, the actual clamping situation current state of the clamping situation being detected according to the invention.

Thus, it can be determined and taken into consideration particularly advantageously if a workpiece is clamped in a manner deviating from a clamping situation target state underlying the original path calculation, that is, relating both to an inclination or rotational displacement and relating to a translational displacement as compared to the clamping situation target state. This clamping situation deviation is advantageously detected in the inventive method by comparing the detected clamping situation current state with the predetermined clamping situation target state, and transformed control data may advantageously be generated in dependence of the detected clamping situation deviation of the workpiece.

The determined control data or at least parts of the control data are changed by transformation or transformed and advantageously used to generate transformed control data in order to generate transformed control data adapted to the actual clamping situation current state and enabling an exact machining of the workpiece. In particular, this has the advantage that when equal workpieces are machined, e.g. in mass production, only one control data set has to be generated in accordance with the specified machining and by means of a clamping situation target state, which can then be transformed individually for each of the individual workpieces in accordance with the actual clamping situation. Especially, the initially generated control data, that is, e.g. an underlying NC program, has advantageously to be generated and transmitted to the machine tool only once for all workpieces. There, an individual transformation can be performed for each workpiece without having to generate and transmit new control data adapted to the clamping situation.

To this end, according to the invention, a tool of the machine tool is moved along a second tool path having a second tool orientation in dependence of the detected clamping situation deviation by using the transformed control data for machining the clamped workpiece, preferably if the workpiece is clamped in the clamping means with the determined clamping situation deviation in accordance with the detected clamping situation current state.

Thus, this offers the advantage that transformed control data is generated by means of which a tool of the machine tool can be controlled in a manner adapted to the actual clamping situation by taking into account the actual clamping situation of the workpiece when generating the transformed control data.

Thus, it is possible to consider or correct a deviation, if any, of the actual present clamping situation current value from the clamping situation target value in the generation of the control data for controlling the tool. Thus, the workpiece is precisely machined by using the transformed control data despite the faulty clamping situation or the clamping situation deviating from the target state, that is, despite a translational and/or rotational deviation from the target clamping situation, in compliance with the initial control data, the transformed control data being generated in such an advantageous manner that the deviation of the clamping situation from the clamping situation target value is corrected by the transformation of the control data into the transformed control data.

In particular, the inventive method, in which both a translational displacement and a rotational displacement of the clamping situation as compared to the target clamping situation are taken into consideration, is especially suited for complex machining, for example on a machine tool comprising at least 5 axes, in which not only a simple grinding movement of a grinding wheel is performed in parallel to the workpiece axis of a rotationally symmetric workpiece, but in which complicated movements of the workpiece have to be controlled relative to the workpiece in 5 degrees of freedom with optionally changing milling or drilling tools, such as, for example, end milling cutters, torus milling cutters, cherries or even drum milling cutters or other drilling or milling tools.

Furthermore, apart from the use for machining rotationally symmetric workpieces, such as gear wheels, the inventive method is also particularly suited for machining non-rotationally symmetric workpieces. Here, it is possible to select any clamping of the workpiece in a surprisingly advantageous manner, wherein the initial control data may already be present in the machine tool and no new control data, that is, e.g. newly generated CNC programs, can be generated and transmitted. According to the invention, the actual clamping situation including a translational as well as a rotational displacement as compared to a target clamping situation is detected which underlies the initially generated control data. Thereupon, transformed control data, that is, e.g. direct travel instructions, can be generated so that the tool performs the predetermined machining movement relative to the workpiece. In this case, it is surprisingly is irrelevant how complex the movement is, that is, whether optionally all of the at least 5 axes are simultaneously moved or controlled. According to the inventive method, even a driving of 5 or more axes at the same time can be performed by means of transformed control data. Particular advantages result from the inventive method in case of particularly complex machining of a symmetric or asymmetric workpiece by using tools along any complex machining paths, optionally even in case of a simultaneous, synchronized driving of all axes of a machine tool comprising at least 5 axes. This is made possible in particular by the fact that the actual clamping situation or clamping situation deviation is determined such that both the rotational and the translational displacement of the actual clamping situation as compared to the target clamping situation is detected in all spatial directions.

Preferably, the above-described control data is detected and determined, respectively, by means of a provided or generated CNC program, the control data preferably corresponding to travel instructions or movement instructions suitable to drive one or more of the axles of the machine tool for controlling the tool and/or the workpiece in order to control a travel of the tool and/or the workpiece. To this end, it is preferred in the above-described method not to modify the CNC programs underlying the control but preferably to transform the travel instructions in dependence of the clamping situation of the workpiece, or preferably to generate directly transformed machine travel instructions based on the unchanged CNC program, i.e. to generate transformed control data, in particular, for example, by an optional zero point shift of the axle control. This is preferably done directly on the machine tool in real time, i.e. directly in the numerical control of the machine tool during the machining of the workpiece.

Preferably, the workpiece is clamped in the clamping means of the machine tool in the clamping situation target state of the workpiece such that a central axis of the workpiece is congruent with an axis of rotation of the clamping means of the machine tool.

This is advantageous in that an axis of rotation of the clamping means, by which the clamped workpiece can be rotated about the axis of rotation of the clamping means, optionally and preferably by using the instructions of control data, is congruent with a central axis of the workpiece in the target state of the clamping situation.

Thus, a deviation or a clamping situation deviation between the current state and the target state of the clamping situation can simply be parameterized by parameters such as, for example, the angularity of the central axis of the workpiece to the axis of rotation of the clamping means of the machine tool and/or a distance parameterization of a distance between the central axis of the workpiece and the axis of rotation of the clamping means, for example, a distance of the points of intersection of the central axes and axes of rotation with a plane orthogonal to the axis of rotation of the clamping means of the machine tool, a distance parameterization indicating e.g. the distance and/or a vectorial direction between the points of intersection of the axis of rotation of the clamping means and the central axis of the workpiece with the orthogonal plane to the axis of rotation of the clamping means at a particular predetermined height of the clamping means of the machine tool.

Preferably, the transformation in the step of generating transformed control data is furthermore executed such that a machining of the workpiece clamped in accordance with the clamping situation current state by using the transformed control data on the machine tool preferably corresponds to the machining of the workpiece clamped in is accordance with the clamping situation target state on the machine tool by using the determined control data.

This is advantageous in that the transformed control data exactly matches the correction of the deviation of the clamping situation of the workpiece from the clamping situation target state so that a workpiece clamped in a manner deviating from the target state is exactly machined by using the transformed control data as a workpiece clamped in accordance with the clamping situation target state would be machined by using the determined control data.

Preferably, the step of detecting the clamping situation current state of the workpiece clamped in the clamping means of the machine tool comprises optical scanning, inductive scanning and/or mechanical scanning of an outer surface of the workpiece or by scanning using another method.

This offers the advantage that by scanning an outside or outer surface of the workpiece on different sides of the workpiece or at different angularities to the workpiece points on the outside or the outer surface of the workpiece can be measured so that the actual clamping situation, that is, the clamping situation current state, can be detected by optical, inductive and/or mechanical scanning.

In this process, it is possible, for example, that the workpiece is optically scanned from different directions at different angularities, in particular by light or another type of electromagnetic radiation at wavelengths in the non-visible range.

Additionally to or instead of the optical scanning, it is possible to mechanically scan an outside or outer surface of the workpiece from different directions at different angularities by a sensing element in order to detect the actual clamping situation.

For this purpose, the workpiece clamped in the clamping means of the machine tool is preferably scanned inductively, optically and/or mechanically by detecting a respective position of preferably different points lying on the outside of the workpiece in order to determine an actual clamping situation in accordance with the clamping situation current state.

Furthermore, the optical, inductive and/or mechanical scanning described above is executed preferably automatically, preferably by a scanning means of the machine tool.

Preferably, in the step of generating control data the determined control data on the machine tool is transformed in real time, that is, directly in the control on the machine tool during the machining, into corresponding machine travel instructions.

This means that preferably the original CNC program is not changed but travel instructions on the machine tool are transformed in real time, i.e. during the machining of the workpiece, by using the determined clamping situation deviation and in dependence of the clamping situation, respectively. Optionally, for executing the travel instructions a zero point shift depending on the clamping situation deviation is performed during this process as correction or transformation on the machine tool in order to take the clamping situation deviation detected in real time into consideration in real time and to execute the corresponding transformation.

Preferably, the determined control data comprises tool position data and preferably tool orientation data, the tool position data preferably indicating a first tool position of the tool at a first point in time and the tool orientation data preferably indicating a first tool orientation of the tool at a first point in time, and the transformation in the step of generating transformed control data preferably comprising a transformation of the tool position data into transformed tool position data and/or preferably a rotation transformation of the tool orientation data into transformed tool orientation data, the transformed tool position data preferably indicating a second tool position of the tool at the first point in time and the transformed tool orientation data preferably indicating a second tool orientation of the tool at the first point in time, the transformation and/or the rotation transformation preferably being such that the first tool position and the first tool orientation relative to the workpiece in the clamping situation target state at the first point in time preferably correspond to the second tool position and the second tool orientation relative to the workpiece in the clamping situation current state at the first point in time.

This is advantageous in that a deviation of the clamping situation of the workpiece in the clamping situation current state at a determined point in time, for example the first point in time, or at a plurality of determined points in time from the corresponding clamping situation target state at the respective point in time can be executed by an exact transformation and/or rotation transformation to be related to this respective point in time, whereby the tool position can be optimally corrected at this respective point in time by using the transformation and the tool orientation by means of the rotation transformation.

Preferably, the method furthermore comprises the step of traveling the second machining path by the tool by using the transformed control data, wherein the transformed control data is preferably generated in real time so that the transformed tool position data and the transformed tool orientation data at the first point in time are essentially generated at the first point in time, and the tool in the step of traveling the second machining path essentially assumes the second tool position and the second tool orientation at the first point in time.

This has the advantage that at first independently of or before the machining of the workpiece on the machine tool according to the prior art, e.g. by using conventional CAD/CAM systems, control data can be generated on the basis of a clamping situation target state, optionally on a computer, whereby in case of a clamping situation possibly deviating from the target state of a workpiece actually clamped in the machine tool the machining of the workpiece can be done optimally in that the control data can be transformed in real time, i.e. during the machining of the workpiece on the machine tool directly through the transformation into the transformed control data in accordance with the actual clamping situation.

This may preferably be performed automatically on the machine tool so that deviations of the clamping situation from the clamping situation underlying the original calculation of the control data can be made independently.

Furthermore, the present invention provides a device for generating transformed control data for controlling a tool on a machine tool for machining a workpiece clamped in a clamping means of the machine tool according to one of the above-described methods, i.e. with optionally one or more of the above-described preferred features.

The inventive device comprises a control data determining means for determining control data indicating which first tool path is to be is traveled by a tool of the machine tool having which first tool orientation for machining the clamped workpiece if the workpiece is clamped in the clamping means in accordance with a clamping situation target state indicating a target state of a clamping situation of the workpiece clamped in the clamping means.

Furthermore, the device according to the present invention is characterized by a clamping situation current state detecting means for detecting a clamping situation current state indicating an actual current state of the clamping situation of the workpiece clamped in the clamping means, a clamping situation deviation detecting means for detecting a clamping situation deviation between the clamping situation current state and the clamping situation target state indicating a deviation between the clamping situation current state and the clamping situation target state, and a control data generating means for generating transformed control data by executing a transformation of at least a part of the determined control data in dependence of the detected clamping situation deviation, a tool of the machine tool being controlled by means of the transformed control data such that the tool travels a second tool path having a second tool orientation for machining the clamped workpiece if the workpiece is clamped in the clamping means in accordance with the detected clamping situation current state with the determined clamping situation deviation.

This is advantageous in that a device is provided which is able to perform the advantageous method as described above, in particular for generating transformed control data that takes into consideration a deviation of the clamping situation of the workpiece from the clamping situation target state and accordingly correct generated control data.

Preferably, the above-described device is furthermore suited to be installed in or inserted into a machine tool, the machine tool comprising the clamping means for clamping the workpiece.

This has the advantage that the device may be installed in a directly integrated manner in the machine tool in order to be thus able to execute the correction of the control data by transformation for generating the transformed control data in real time during the machining of the workpiece.

Preferably, the machine tool furthermore comprises at least 5 axes, the 5 axes being simultaneously controllable by using CNC control data. Here, the machine tool preferably is a milling/turning machine tool, a turning/milling machine tool, a milling/drilling machine tool comprising at least 5 axes or also a universal machining center comprising at least 5 axes.

This has the advantage that the tool can be moved along a calculated path in 5 degrees of freedom of movement comprising 3 degrees of freedom of translation and 2 degrees of freedom of rotation for controlling the tool. The flexibility and freedom of movement through the 5 degrees of freedom furthermore guarantee that a necessary transformation for correcting the control data for generating the transformed control data may actually also be performed kinematically by the tool guidance.

Furthermore, the machine tool preferably comprises a scanning means, the step of detecting the clamping situation current state of the workpiece clamped in the clamping means of the machine tool comprising the optical, inductive and/or mechanical scanning of an outer surface of the workpiece, and furthermore the optical, inductive and/or mechanical scanning preferably being executed in a preferably automatic manner by the scanning means of the machine tool.

This is advantageous in that the machine tool itself comprises scanning means with which it is possible to detect the clamping situation current state of the workpiece clamped in the clamping means of the machine tool.

Furthermore, the present invention provides a machine tool having at least 5 axes for machining a workpiece by means of a tool using control data, the control data indicating which tool path is to be traveled by the tool having which tool orientation for machining the clamped workpiece, wherein the machine tool furthermore comprises clamping means for clamping the workpiece and in particular is equipped by one of the above-described devices according to the present invention or comprises such device.

Preferably, the machine tool comprises a scanning means, the step of detecting the clamping situation current state of the workpiece clamped in the clamping means of the machine tool comprising optical scanning, inductive scanning and/or mechanical scanning of preferably an outer surface of the workpiece, the optical, inductive and/or mechanical scanning being preferably executed in an automatic manner by the scanning means of the machine tool.

Finally, the machine tool furthermore preferably comprises a dividing head and/or a fully integrated rotational axis, the dividing head and the rotational axis, in particular preferably an NC dividing head and a fully integrated NC rotational axis, respectively, being provided with a clamping means for clamping a workpiece, the dividing head and/or the rotational axis furthermore preferably being suitable to rotate the clamped tool about an axis of rotation of the clamping means.

This offers the advantage that the inventive method and the inventive device may furthermore be adopted or used for machine tools in which not only the clamping of a workpiece in a clamping means of the machine tool, for example on a tool table, is made possible but additionally a clamping of a workpiece in a clamping means of a dividing head which in turn may optionally be clamped in a clamping means of the machine tool, e.g. on a tool table.

This offers the advantage that the inventive method and the inventive device may be adopted for conventional machine tools and conventional machine tools having a dividing head, in particular having an NC dividing head.

Finally, the present invention provides a computer program product which is characterized in that a computer in combination with the computer program product or in combination with a program for generating control data, in particular, for example a CAD/CAM program, and the computer program product is suitable to technically execute at least one of the above-described methods for generating control data and to optionally transmit the generated transformed control data via an interface of the computer to the machine tool. Accordingly, the present invention furthermore provides a data carrier which is characterized in that the above-described computer program product is stored on the data carrier.

### BRIEF DESCRIPTION OF THE FIGURES

FIG. 1 exemplarily shows a schematic illustration of a machine tool for machining a workpiece clamped in a clamping means of the machine tool.

FIG. 2 exemplarily shows a schematic illustration of a clamping situation target state of a workpiece as underlying the generation of control data for controlling a tool of the machine tool.

FIG. 3A exemplarily shows a schematic illustration of the clamping situation target state of a workpiece of FIG. 1 in a cross-sectional view.

FIG. 3B exemplarily shows a schematic illustration of a clamping situation current state of the workpiece at a first point in time in a cross-sectional view, which state has a clamping situation deviation with respect to the clamping situation target state shown in FIG. 3A.

FIG. 3C exemplarily shows a schematic illustration of a cross-section of the workpiece of FIG. 3A in a clamping situation target state and a corresponding first tool position and first tool orientation of a tool at a first point in time.

FIG. 3D exemplarily shows a schematic illustration of a cross-section of the workpiece of FIG. 33 in a clamping situation current state at a first point in time and a corresponding second tool position and second tool orientation of the workpiece at the first point in time according to transformed control data generated in an embodiment of the inventive method.

FIG. 4A exemplarily shows a schematic illustration of a transformation of the workpiece position in accordance with an embodiment of the method for generating transformed control data according to the present invention.

FIG. 4B exemplarily shows a schematic illustration of a transformation of a tool orientation in accordance with an embodiment of the method for generating transformed control data according to the present invention.

FIG. 5 shows a schematic illustration of an embodiment of a device for generating transformed control data according to the present invention.

### DETAILED DESCRIPTION OF THE FIGURES AND PREFERRED EMBODIMENTS OF THE INVENTION

In the following, the present invention will be described and explained in detail by means of embodiments of the method and the device for generating transformed control data according to the present invention by using exemplary figures.

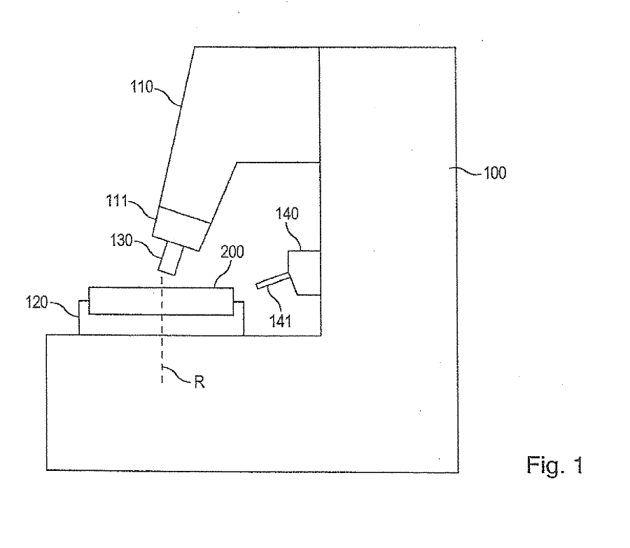

FIG. 1 exemplarily shows a machine tool 100 which is suitable to control a tool 130 for machining a workpiece 200 by using generated control data. In this embodiment described below the machine tool 100 is a milling and drilling machine tool comprising 5 axes which is suitable to remove a tool 130 inserted into a receiving means by program-control using generated CNC control data by means of predetermined calculated tool paths for removing material from the workpiece 200, which is clamped in a clamping device and a clamping means 120, respectively, of the machine tool 100, along the tool paths.

To this end, the machine tool 100 comprises a clamping means 120 for clamping the workpiece 200. In the present embodiment of the machine 100, the clamping means 120 is a clamping means 120 mounted on a tool table of the machine tool 100 for clamping the workpiece 200 so that by rotating the tool table the workpiece 200 can be rotated about a central axis M of the clamping means 120 through rotation of the clamping means 120.

However, the present invention is not limited to generating control data for machining a workpiece clamped in the clamping means of a tool table but may furthermore be used for machining in different clamping means, for example, in the case of clamping a workpiece in a clamping means of a dividing head, in particular an NC dividing head.

Moreover, the machine tool 100 in the embodiment described here in FIG. 1 comprises a control device 110 which is suitable to control the tool 130 by using the generated CNC control data. To this end, the control device 110 of the machine tool 100 comprising 5 axes is suitable to move the tool in a translational manner in 3 linear axis directions, the linear axes in the following being referred to as x-axis, y-axis and z-axis.

Furthermore, the control device 110 is suited for guiding the tool 130 about a rotational axis in order to thus enable a tool orientation of the tool. Thus, together with the rotational movement axis of the clamping means 120 and the tool table, respectively, a total number of 5 axes results which make it possible to freely move the tool 130 relative to the workpiece 200 clamped in the clamping means 120 in 5 degrees of freedom of movement, in particular 3 translational and 2 rotational degrees of freedom of movement.

However, the present invention is not limited to machine tools comprising 5 axes but rather can also be used for machine tools comprising more than 5 axes, for example, 6 axes, in particular 3 translational and 3 rotational axes. Machine tools having fewer than 5 axes are also possible.

The control device 110 in FIG. 1 comprises a spindle 111 which is suitable to drive the tool 130, in particular to drive a rotational movement of the tool 130 about a tool axis of the tool 130 in order to enable the removal of material from the workpiece 200 by machining, in particular milling and/or drilling.

Furthermore, the machine tool 100 shown in FIG. 1 comprises a scanning means 140 including a sensing element 141 which is suitable to scan the workpiece 200, in particular to can the workpiece 200 several times in different angularities about the axis of rotation M of the clamping means 120 in order to make it possible to detect a clamping situation of the workpiece 200 in the clamping means 120.

However, the present invention is not limited to the use in machine tools 100 comprising such scanning means 140 including a sensing element 141. Rather, it is also possible to detect a clamping situation of the workpiece 200 in the clamping means 120 by mechanical scanning using a sensing element 141, in particular in different angularities about the axis of rotation of the clamping means 120, the sensing element 141 being exchanged or replaced in a control device 110 in accordance with a tool 130 contrary to the above-described embodiment of the machine tool.

Furthermore, the above-described embodiments of a machine tool 100 describe the detection of a clamping situation of the workpiece 200 in the clamping means 120 by mechanical scanning using a sensing element 141. However, the present invention is not limited to such machine tools 100 in which the clamping situation of the workpiece 200 is made by mechanical scanning but rather can also be adopted for machine tools comprising a scanning means 140 suitable to detect the clamping situation of the workpiece in the clamping means 120 by optical scanning, e.g. by a laser beam.

Apart from optical scanning by means of a laser beam it is furthermore possible to detect the workpiece by electromagnetic radiation which is not in the optical wavelength range. In particular, it is also possible to adopt the present invention for machine tools 100 comprising a scanning means 140 which detects a clamping situation of the workpiece 200 in the clamping means 120 by a combination of mechanical scanning by a sensing element 141 and optical and/or electromagnetic scanning.

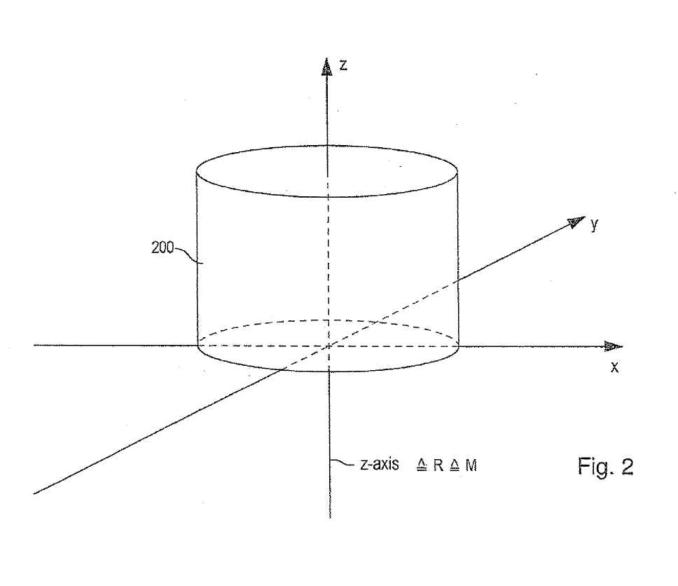

FIG. 2 exemplarily shows a clamping situation target state of a workpiece 200. As in a 5-axis CNC machine tool the tool 130 is made by means of generated CNC control data, it is required to predefine tool paths by the control data by means of which the machine tool 100 and the control device 110, respectively, move the tool 130, here an end milling cutter by way of example, relative to the workpiece clamped in the clamping means 120. According to the prior art, the generation of control data for controlling the tool 130 is based on a clamping situation corresponding to the clamping situation target state.

In FIG. 2, such clamping situation target state is shown for an exemplary cylinder-shaped workpiece 200, FIG. 2 exemplarily illustrating the directions of the x-axis, y-axis and z-axis. For the sake of simplicity, the clamping means 120 is not shown in FIG. 2. However, in the clamping situation target state shown in FIG. 2, a central axis M of the workpiece 200 corresponding to the z-axis is congruent with the axis of rotation R of the clamping means 120, the axis of rotation R corresponding to the axis about which the clamping means 120 makes it possible to rotate a workpiece 200 clamped in the clamping means 120.

As the central axis M of the clamped workpiece 200 and the axis of rotation R of the clamping means 120 are congruent in the clamping situation target state illustrated in FIG. 2, the clamped workpiece 200 identically rotates about the own central axis M of the workpiece 200 when about the axis of rotation R of the clamping means 120. In particular, due to the congruence when the workpiece 200 rotates about the axis of rotation R of the clamping means 120, the central axis M of the workpiece 200 does not perform any tumbling movement about the axis of rotation R of the clamping means 120.

Using the control data, a tool 130 would remove material from the clamped workpiece 200 along the tool paths predetermined by the control data. However, if the actual clamping situation of the clamped workpiece 200 deviates from the clamping situation target state shown in FIG. 2, the workpiece 200 will be machined in a faulty manner on the basis of the control data because the control data was generated according to the clamping situation following the clamping situation target state.

If here e.g. the clamping situation of the workpiece 200 deviates such that the central axis M of the workpiece 200 has an inclination or an angle towards the axis of rotation R of the clamping means 120, this results in a tumbling movement of the workpiece 200 or a tumbling movement of the central axis M when the workpiece 200 rotates about the axis of rotation R of the clamping means 120 because the central axis M of the workpiece 200 is not congruent with the axis of rotation R of the clamping means 120.

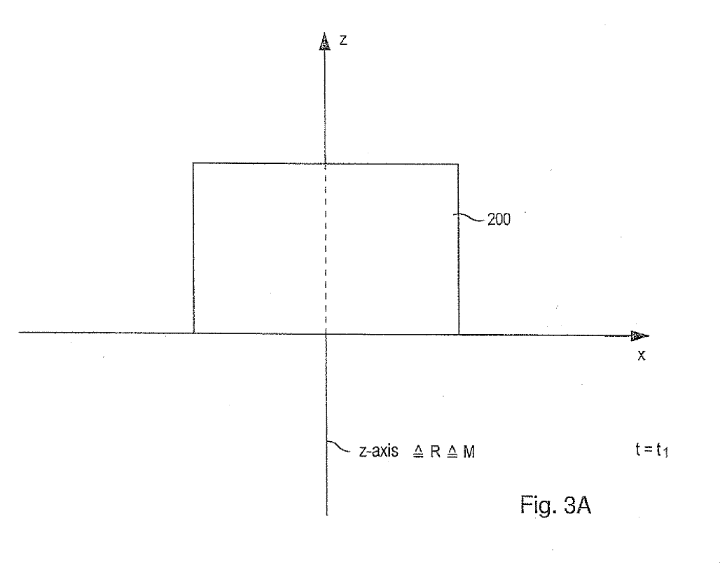

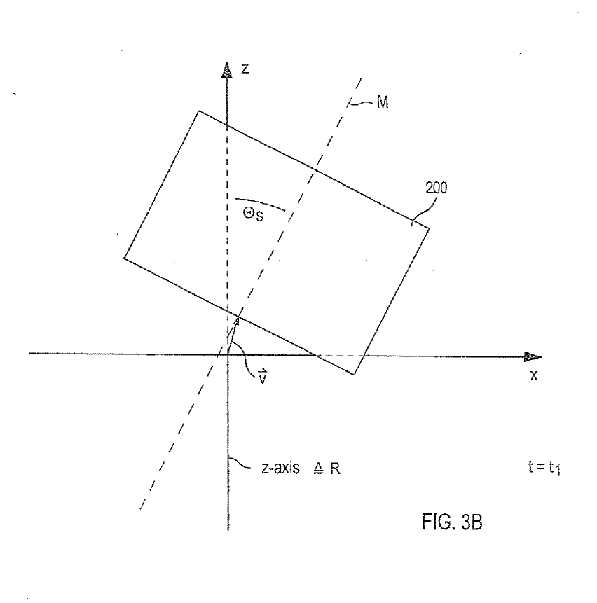

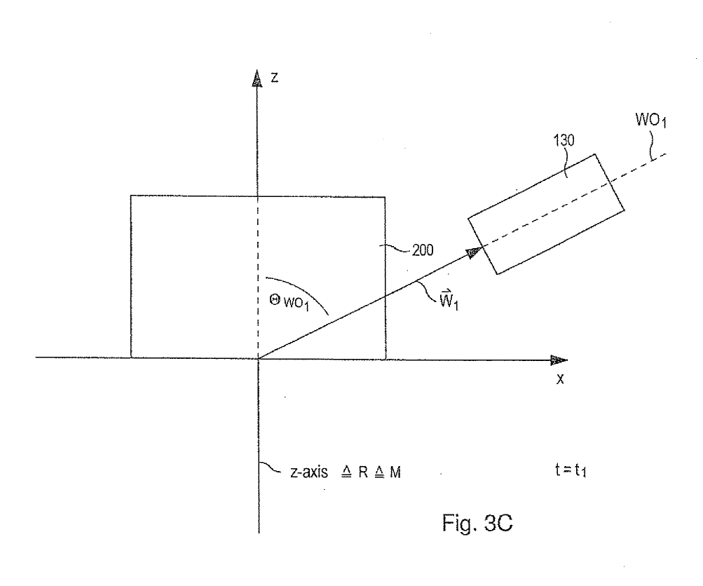

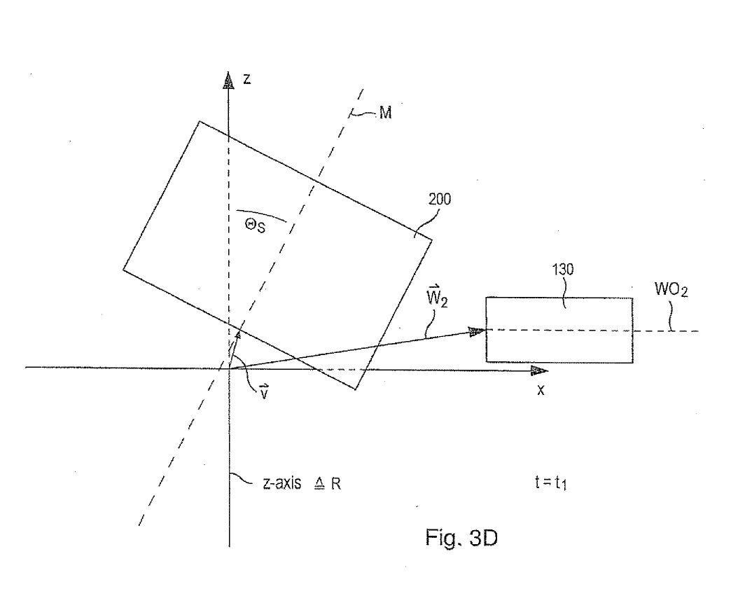

FIG. 3A shows a cross-section of the workpiece 200 illustrated in FIG. 1 at a first point in time t1 in the clamping situation target state illustrated in FIG. 2, that is, with the central axis M of the workpiece 200 being congruent with the axis of rotation R of the clamping means 120 (not shown).

An exemplary clamping situation current state at the first point in time t1 is shown in a cross-section in FIG. 3B. In contrast to FIG. 3A, the central axis M of the clamped workpiece 200 deviates from the axis of rotation R of the clamping means 120 by an angle θₛ. Additionally to the angle deviation of the actual clamping situation current state from the clamping situation target state, the clamping situation current state in FIG. 3B at the first point in time t1 furthermore deviates such that a position of the workpiece 200 is translationally shifted by the illustrated vector v in addition to the inclination by the angle θₛ.

The deviation or clamping situation deviation between the clamping situation target state and the clamping situation current state can thus be described at the first point in time t1 by the angle deviation θₛ between the central axis M of the workpiece 200 and the axis of rotation R of the clamping means 120 and the positional shift given by the vector v at the first point in time t1.

FIG. 3C again shows the cross-section of the workpiece 200 at the first point in time t1 in the clamping situation current state, as illustrated in FIG. 3A, wherein a tool positioning of the tool 130 at the first point in time t1 is additionally shown in FIG. 3C, as it would result at the first point in time t1 by means of the generated control data. This means that the control data is generated such that the machine tool 100 controls the tool 130 along a calculated tool path by means of the control device 110 such that the tool assumes a tool position and a tool orientation as shown in FIG. 3C at the first point in time t1.

Here, the tool position corresponding to a first tool position W₁ is vectorially shown (given by 3 coordinates along the x-axis, y-axis and z-axis). An orientation of the tool 130 at the first point in time t1 is given by a first tool orientation WO₁ described by an angle θ_{WO1}. In this case the control data contain data indicating the tool positioning at the first point in time t1, in particular tool position data indicating the three coordinates of the vector W₁ at the first point in time t1, and tool orientation data indicating the first tool orientation WO1 of the tool 130 at the first point in time t1 by means of the angle θ_{WO1}.

The illustration in FIG. 3C is a simplified illustration in which a point in time t1 has been chosen as an example at which the tool orientation is currently in the x-z plane. Generally, however, the tool orientation is not only given by an angle θ_{WO1} as in FIG. 3C but by at least two angles (corresponding to the two rotational degrees of freedom). However, by indicating 3 coordinate values (position data) and 2 angle values (orientation data) the respective tool positionings can be exactly parameterized because all 5 degrees of freedom which can be simultaneously driven by the 5 axes of the CNC machine are determined at a particular point in time, for example at the first point in time t1, by the 3 position coordinates and 2 angle parameters.

The tool positioning shown in FIG. 3C is predefined by the control data by using the tool position data and the tool orientation data for the first point in time t1, assuming that the clamping situation of the workpiece 200 corresponds to the clamping situation target state with congruent axes M and R when generating the control data. If the actual clamping situation current state of the workpiece 200 now deviates from the clamping situation target state, the tool 130 is taken to a tool orientation and tool position by using the control data, which do not correspond to the desired tool positioning relative to the tool, at the first point in time t1.

FIG. 3D shows the workpiece 200 in the cross-section corresponding to the clamping situation current state shown in FIG. 3B at the first point in time t1, wherein furthermore a tool positioning of the tool 130 in accordance with a predefinition by transformed control data generated according to the invention is shown so that the tool positioning in FIG. 3D relative to the workpiece 200 exactly corresponds to the tool positioning of the tool 130 relative to the workpiece 200, as illustrated in FIG. 3C.

To this end, the tool is controlled such that the tool position at the first point in time t1 corresponds to the second tool position W₂ which is illustrated by the vector W₂ in FIG. 3D and that furthermore the tool orientation of the tool 130 at the first point in time corresponds to a second tool orientation WO₂.

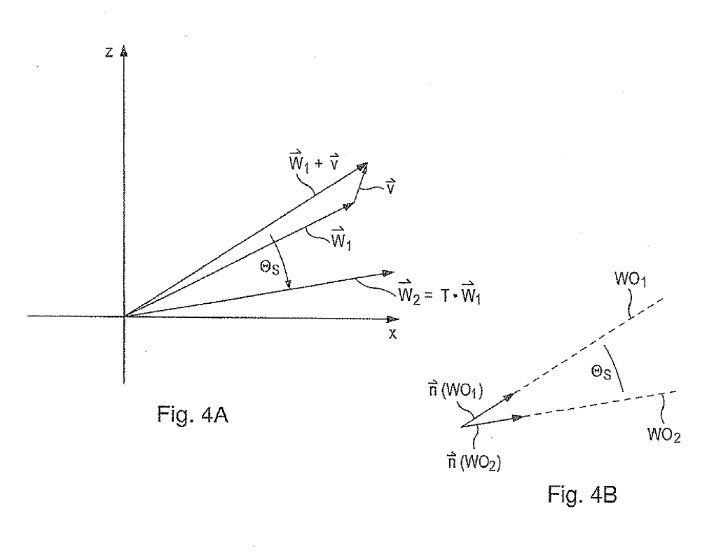

FIGS. 4A and 48 show a transformation of the tool position data of the control data at the first point in time t1 into the transformed tool position control data of the transformed control data and a transformation of the tool orientation data of the control data into the transformed tool orientation data of the transformed control data at the first point in time t1.

FIG. 4A shows the vector W₁ indicating a first tool position at the first point in time t1 according to FIG. 3C. The transformation of the control data indicating the coordinates of the vector W₁ at the first point in time t1 thus results by adding the vector v corresponding to a positional shift of the workpiece (translational deviation between clamping situation current state and clamping situation target state), as shown in FIG. 3B, so that at first another vector W_{I}+v results. However, it does not yet correspond to the transformed tool position data, but to this end it must furthermore be transformed such that the vector W₁₊ᵥ is rotated in the angle θₛ, the angle θₛ corresponding to the rotational deviation between the clamping situation current state and the clamping situation target state, as shown in FIG. 3B. Thus the second tool position, described by the coordinates of vector W₂, at the first point in time t1 results from transformation about the vector v and another rotation transformation about the angle θₛ or, in other words, by a single transformation in accordance with a transformation matrix T so that the following formation is made from the tool position data to the transformed tool position data as follows:

W₂=T·W₁.

In analogy, FIG. 4B shows the transformation (rotational transformation) of the tool orientation data from the tool orientation data into the transformed tool orientation data. FIG. 4B describes the tool orientation by normal vectors n(WO₁) and n(WO₂) describing the directions of the first tool orientation WO₁ and the second tool orientation WO₂ which deviate by the angle θₛ, as illustrated in FIGS. 3C and 3D. Thus, the transformation from the tool orientation data into the transformed tool orientation data and from the first tool orientation WO₁ and the second tool orientation WO₂, respectively, is a pure rotational transformation about the angle θₛ.

Generally, this rotational transformation is parameterized at a particular point in time, however not by only one angle θₛ, as in FIGS. 3A and 4B, but by two angles so that arbitrary tool orientations can be parameterized into arbitrary tool orientations deviating therefrom even if they are not in the z-x plane, as shown in FIG. 4B.

As described above, according to the invention transformed control data is thus generated by using the control data, wherein the transformation is made according to the invention in dependence of a detected deviation between the clamping situation target state and the clamping situation current state such that the machine tool 100 and the control device 110, respectively, control the tool 130 by using the transformed control data for machining the workpiece 200 such that the workpiece is correctly machined despite the clamping situation deviating from the clamping situation target state so that the machining exactly corresponds to a machining of the workpiece 200 if the latter were machined when clamped in a clamping situation corresponding to the clamping situation target state by using the control data.

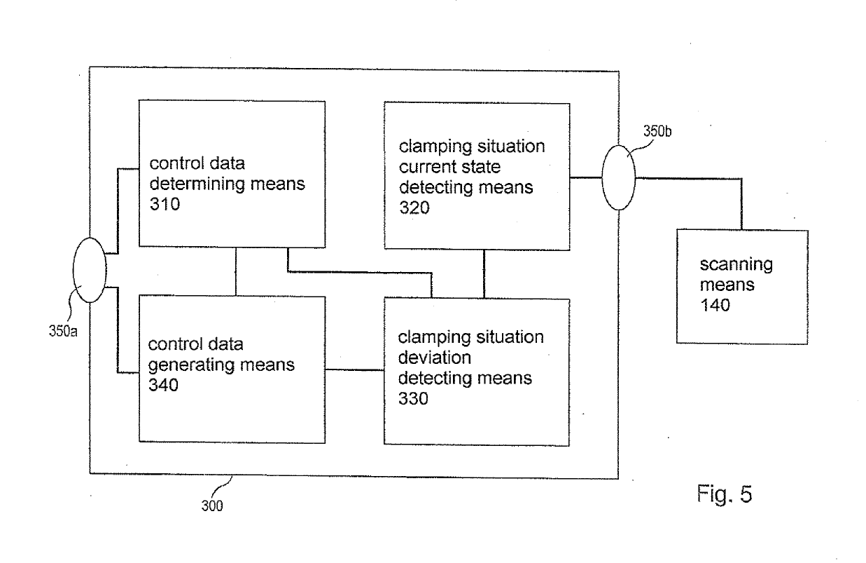

FIG. 5 shows an embodiment of an inventive device 300 for generating transformed control data for controlling the tool 130 on the machine tool, the device 300 comprising a control data determining means 310, a clamping situation current state detecting means 320, a clamping situation deviation detecting means 330 and a control data generating means 340.

The control data determining means 310 is suitable to determine control data indicating which first tool path is to be traveled by the tool 130 of the machine tool 100 having which tool orientation for machining the clamped workpiece 200 if the workpiece were clamped according to the clamping situation target state.

For this purpose, the device 300 according to the present embodiment comprises an interface 350a which is suitable to communicate with a means for generating control data in order to enable the control data determining means 310 to determine the control data generated by another system via the interface 350a. To this end, it is furthermore required that the control data determining means 310 determines the clamping situation target state underlying the control data.

However, the present invention is not limited to embodiments in which the control data determining means 310 can determine generated control data from an external source via an interface 350a but rather the device 300 according to another embodiment of the present invention can be a component of the system, in particular of a computer system in combination with a CAD/CAM system which already generates the control data.

The clamping situation current state detecting means 320 is suitable to detect the actual clamping situation of the workpiece 200, wherein in this embodiment the clamping situation current state detecting means 320 is connected via an interface 350b (alternatively also via the interface 350a) to a scanning means 140 of the machine tool 100, which scanning means performs the clamping situation or the clamping situation current state of the workpiece 200 by mechanically and/or optically scanning the workpiece 200 in different angular positions.

Furthermore, the device 300 comprises a clamping situation deviation detecting means 330 which is suitable to detect a clamping situation by using the clamping situation of the workpiece 200 detected by the clamping situation current state detecting means 320 in comparison with the clamping situation target state, which optionally detects a rotational deviation of the central axis M of the clamped workpiece 200 from the axis of rotation R of the clamping means 120, and furthermore a translational shift in accordance with, for example, vector v in FIG. 3B.

Furthermore, the device 300 comprises a control data generating means 340 which is suitable to generate transformed control data according to at least one of the above embodiments of the method of the present invention. According to this embodiment, the control data generating means 340 is suitable to communicate with a control device of the machine tool 100 via the interface 350a such that the machine tool 100 can control the tool 130 by using the control data generated by the control data generating means 340. To this end, the device 300 may be attached to the machine tool 100 in an embodiment of the present invention or integrated in the machine tool so that the transformed control data can optionally be generated in real time, the control data generating means 340 generating the transformed control data such that the control data is generated by the control data generating means in an essentially simultaneous manner at such a particular point in time and that the tool is controlled by program-control by using the generated control data.

However, the present invention is not limited to such generation of the transformed control data performed in real time but rather transformed control data can further be generated at first by using the control data and the detected deviation of the clamping situation between the clamping situation current state and the clamping situation target state so that the generated transformed control data are transmitted to the machine tool 100 only in a subsequent step so that the tool 130 can be controlled by means of the control data.

1. A method for generating control data for controlling a tool on a machine tool for machining a workpiece clamped in a clamping means of the machine tool, comprising the method step:
determining control data for controlling the tool of the machine tool along a first tool path having a determined first tool orientation for machining the clamped workpiece in accordance with a clamping situation target state indicating a target state of a clamping situation of the workpiece clamped in the clamping means,
comprising the further method steps:
detecting a clamping situation current state indicating an actual current state of the clamping situation of the workpiece clamped in the clamping means,
detecting a clamping situation deviation between the clamping situation current state and the clamping situation target state indicating a deviation between the clamping situation current state and the clamping situation target state, and
generating transformed control data by executing a transformation of at least a part of the determined control data in dependence of the detected clamping situation deviation,
the tool being controlled by means of the transformed control data such that the tool of the machine tool travels along a second tool path having a determined second tool orientation in dependence of the detected clamping situation deviation for machining the clamped workpiece.

2. The method according to claim 1, wherein the workpiece is clamped in the clamping means of the machine tool in the clamping situation target state such that a central axis of the workpiece is congruent with an axis of rotation of the clamping means of the machine tool tool.

3. The method according to claim 1, wherein the transformation is executed such in the step of generating transformed control data that a machining of the workpiece clamped in accordance with the clamping situation current state by means of the transformed control data on the machine tool corresponds to machining the workpiece clamped in accordance with the clamping situation target state by means of the determined control data on the machine tool.

4. The method according to claim 1, wherein the step of detecting the clamping situation current state of the workpiece clamped in the clamping means of the machine tool comprises the optical scanning, inductive scanning and/or mechanical scanning of an outer surface of the workpiece.

5. The method according to claim 4, wherein the workpiece clamped in the clamping means of the machine tool is optically, inductively and/or mechanically scanned for determining an actual clamping situation in accordance with the clamping situation current state by detecting a respective position of different points lying on the outer surface of the workpiece.

6. The method according to claim 4, wherein the optical scanning, inductive scanning and/or mechanical scanning is automatically made by a scanning means of the machine tool.

7. The method according to claim 1, wherein in the step of generating control data the determined control data on the machine tool are transformed into corresponding machine travel instructions in real time.

8. The method according to claim 1, comprising the step of traveling along the second machining path by the tool by means of the transformed control data, the transformed control data being generated in real time.

9. A device for generating control data for controlling a tool on a machine tool for machining a workpiece clamped in a clamping means of the machine tool according to a method of claim 1, comprising:
a control data determining means for determining control data for controlling the tool of the machine tool along a first tool path by the tool of the machine tool having a determined first tool orientation for machining the clamped workpiece if the workpiece is clamped in the clamping means in accordance with a clamping situation target state indicating a target state of a clamping situation of the workpiece clamped in the clamping means,
a clamping situation current state detecting means for detecting a clamping situation current state indicating an actual current state of the clamping situation of the workpiece clamped in the clamping means,
a clamping situation deviation detecting means for detecting a clamping situation deviation between the clamping situation current state and the clamping situation target state indicating a deviation between the clamping situation current state and the clamping situation target state, and
a control data generating means for generating transformed control data by executing a transformation of at least a part of the determined control data in dependence of the detected clamping situation deviation,
the tool being controlled by means of the transformed control data such that the tool of the machine tool travels along a second tool path having a determined second tool orientation in dependence of the detected clamping situation deviation for machining the clamped workpiece.

10. The device according to claim 9, wherein the device is suitable for installation in a machine tool, the machine tool comprising the clamping means for clamping the workpiece.

11. The device according to claim 10, wherein the machine tool comprises at least 5 axes, the 5 axes being simultaneously drivable by means of CNC control data.

12. The device according to claim 10, wherein the machine tool comprises a scanning means and the step of detecting the clamping situation current state of the workpiece clamped in the clamping means of the machine tool comprises optical scanning, inductive scanning and/or mechanical scanning of an outer surface of the workpiece by a sensing element of the scanning means, the optical, inductive and/or mechanical scanning being automatically executed by the scanning means of the machine tool.

13. A machine tool comprising at least 5 axes for machining a workpiece by means of a tool including a clamping means for clamping the workpiece and a control means for controlling the tool by means of control data indicating which tool path is to be traveled by the tool having which tool orientation for machining the clamped workpiece, wherein the machine tool comprises a device according to claim 9.

14. The machine tool according to claim 13, wherein the machine tool further comprises a scanning means and the step of detecting the clamping situation current state of the workpiece clamped in the clamping means of the machine tool comprises optical scanning, inductive scanning and/or mechanical scanning of an outer surface of the workpiece, the optical, inductive and/or mechanical scanning being automatically executed by the scanning means, in particular the mechanical scanning being automatically executed by a sensing element of the scanning means.

15. The machine tool according to claim 13, wherein the machine tool comprises a dividing head, the dividing head having the clamping means for clamping the workpiece and being suitable to rotate the clamped workpiece about an axis of rotation of the clamping means.

16. A computer program product comprising a computer readable medium and a computer program stored therein, the computer program being stored in the form of a sequence of states corresponding to instructions which are established so as to be processed by a data processing means of a data processing device so that the data processing device in combination with the computer program product or in combination with a program for generating control data and the computer program product is suitable to execute a method according to claim 1.
